(19) United States
(12) Patent Application Publication
(10) Pub. No.: US 2022/0333038 A1
(43) Pub. Date: Oct. 20, 2022

(54) DETERGENT COMPOSITION

(71) Applicant: Conopco, Inc., d/b/a UNILEVER, Englewood Cliffs, NJ (US)

(72) Inventors: Stephen Norman BATCHELOR, Chester (GB); Niel Stephen BURNHAM, Liverpool (GB)

(73) Assignee: Conopco, Inc., d/b/a UNILEVER, Englewood Cliffs, NJ (US)

(21) Appl. No.: 17/638,554

(22) PCT Filed: Sep. 1, 2020
(86) PCT No.: PCT/EP2020/074343

§ 371 Date: Feb. 25, 2022

(30) Foreign Application Priority Data
Sep. 2, 2019 (EP) 19194932.0

(51) Int. Cl. C11D 3/20; C11D 11/00; C11D 3/00; C11D 3/386; C11D 3/37

(52) U.S. Cl. CPC C11D 3/2093; C11D 11/0017; C11D 3/0036; C11D 3/38618; C11D 3/38645; C11D 3/3715

(57) ABSTRACT

The invention concerns a detergent composition, comprising: a) from 2 to 95 wt. %, preferably from 2.5 to 50 wt. %, more preferably from 5 to 50 wt. % of a citric acid ester derivative of a monoglyceride of the form: —wherein one of R₁, R₂, and R₃ is selected from a C₁₆ to C₁₈ fatty acid chain; and one or two of R₁, R₂, and R₃ is selected from citric acid, the remainder, if any, being OH; and, 10 b) from 0.0001 to 5 wt. %, of further laundry ingredients selected from: perfumes, protease enzymes, amylase enzymes, cellulase enzymes and preservatives; and to a domestic method of treating a textile comprising treatment of the textile with an aqueous solution of 0.15 to 20 g/L of the detergent composition of the first aspect of the invention.

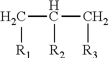

### FIELD OF INVENTION

The present invention concerns a laundry detergent composition. More particularly a laundry detergent composition comprising a surfactant which is a citric acid ester of a monoglyceride.

### BACKGROUND OF THE INVENTION

Citric acid esters of a monoglyceride are surfactants used in food processing, for example in oils and fats to reduce spattering during frying or in chocolate to prevent blooming. They are produced from animal and plant based ingredients.

Domestic laundering of textiles is typically done using synthetic detergents. These have been engineered to work in a variety of challenging environments, such as for example in hard water environments. There is a desire to launder textiles using materials derivable from natural materials. There is a desire that such materials should function well in hard water conditions.

### SUMMARY OF THE INVENTION

The invention relates in a first aspect to a laundry detergent composition comprising:
a) from 2 to 95 wt. %, preferably from 2.5 to 50 wt. %, more preferably from 5 to 50 wt. % of a citric acid ester derivative of a monoglyceride of the form:—

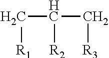

wherein one of R₁, R₂, and R₃ is selected from a C₁₆ to C₁₈ fatty acid chain and one or two of R₁, R₂, and R₃ is selected from citric acid, the remainder, if any, being OH; and,
b) from 0.0001 to 5 wt. % of further laundry ingredients selected from perfumes, protease enzymes, amylase enzymes, cellulase enzymes and preservatives.

In a second aspect the present invention provides a domestic method of treating a textile, the method comprising the steps of:—
a) treating a textile with an aqueous solution of 0.15 to 20 g/L, more preferably 1 to 10 g/L of the detergent composition according to the first aspect of the invention;
b) optionally rinsing and drying the textile.

Preferably the laundry detergent composition is a liquid, gel or a powder, more preferably the detergent is a liquid detergent, most preferably an aqueous liquid laundry detergent.

Preferably the fatty acid chain component of the citric acid ester of a monoglyceride is a linear or branched, preferably linear, saturated or monounsaturated chain.

Preferably the fatty acid chain component is preferably selected from palmitic, cis and trans palmitoleic, stearic, oleic and elaidic, most preferably palmitic and stearic.

Preferably only one of R₁, R₂, and R₃ is selected from citric acid.

Preferably the laundry detergent composition comprises an nonionic surfactant selected from saturated and mono-unsaturated aliphatic alcohol ethoxylates and saturated and mono-unsaturated fatty acid sugar esters; preferably the non-ionic surfactant is saturated and mono-unsaturated aliphatic alcohol ethoxylates, preferably selected from C₁₂ to C₂₀ primary linear alcohol ethoxylates with an average of from 5 to 30 ethoxylates, more preferably C₁ to C₁₈ with an average of from 7 to 20 ethoxylates.

Preferably the laundry detergent composition comprises an anionic surfactant selected from: rhamnolipids, tartartic acid esters and diacetyltartaric acid esters of a C₁ to C₁₈ monoglyceride (tatem and datem), C₁₂ to C₁₈ alkyl ether carboxylate and water-soluble alkali metal salts of organic sulphates, ether sulphates and sulphonates having alkyl radicals containing from about 8 to about 22 carbon atoms.

The laundry detergent preferably comprises from 0.1 to 8 wt. % more preferably from 0.2 to 6 wt. %, most preferably from 0.5 to 5 wt. % of an alkoxylated polyamine. Preferably the alkoxylated polyamine comprises an alkoxylated polyethylenimine, and/or alkoxylated polypropylenimine, more preferably the alkoxylation is ethoxylation or propoxylation or a mixture of both.

The laundry detergent composition preferably comprises from 0.1 to 8 wt. %, more preferably from 0.2 to 6 wt. %, most preferably from 0.5 to 5 wt. % of a soil release polymer, preferably a polyester soil release polymer.

Preferably the laundry detergent composition comprises one or more enzymes further enzymes selected from the group: lipases, peroxidases/oxidases, pectate lyases, and/or mannanases.

Preferably the laundry detergent composition when a liquid detergent, has a viscosity greater than or equal to 1 cP (centipoise), preferably from 1 to 6000 cP, more preferably from 200 to 1000 cP, said viscosity measured at a shear rate of 21 s−1 and at a temperature of 25° C. on any commercial stress rheometer, available for example from Anton Paar or Malvern. This shear rate is the shear rate that is usually exerted on the liquid when poured from a bottle.

Preferably the pH of the formulation when dissolved at 2 g/L in demineralised water at 20° C. is from pH 3 to 10, preferably from 4 to 8, more preferably 6.5 to 7.5.

### DETAILED DESCRIPTION OF THE INVENTION

The indefinite article “a” or “an” and its corresponding definite article “the” as used herein means at least one, or one or more, unless specified otherwise.

All % levels of ingredients in compositions (formulations) listed herein are in wt. % based on total formulation unless other stated.

It is understood that any reference to a preferred ingredient of the detergent composition is envisaged to be combinable subject matter with any other preferred ingredient of the detergent composition disclosed herein.

The formulation may be in any form for example a liquid, solid, powder, liquid unit dose.

Hard water is termed herein where water hardness as classified by degrees of French Hardness is 20° fH (degrees French Hardness or greater).

Citric Acid Derivative of Monoglycerides

Citric acid esters of a monoglyceride are discussed in in Hasenhuettl, G. L and Hartel, R. W. (Eds) Food Emulsifiers and Their Application 2008 (Springer), and in Whitehurst, R. J. (Ed) Emulsifiers in Food Technology 2008 (Wiley-VCH) and in the 2nd edition of this book edited by V. Norn 2015 (Wiley-Blackwell).

The citric acid ester of a monoglyceride are of the form:

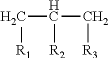

wherein one of R₁, R₂, and R₃ is selected from a C₁₆ to C₁₈ fatty acid chain and one or two of R₁, R₂, and R₃ is selected from citric acid, the remainder being OH.

Weights of the citric acid ester derivative of monoglyceride are for the protonated form.

Preferably only one of R₁, R₂, and R₃ is selected from citric acid.

The fatty acid chains are of the formula R₄COO— where R₄ is a linear or branched, saturated or unsaturated C₁₅ to C₁₇ alkyl chain.

Preferably the fatty acid chain component of the citric acid ester of a monoglyceride is linear.

Preferably the fatty acid chain is saturated or mono-unsaturated.

The fatty acid chain component is preferably selected from palmitic, cis and trans palmitoleic, stearic, oleic and elaidic. Most preferably palmitic and stearic.

Natural fatty acids may be derived from the triglycerides of naturally occurring fats or oils such as rapeseed oil, castor oil, maize oil, cottonseed oil, olive oil, palm oil, safflower oil, sesame oil, soybean oil, sunflower oil, non-edible vegetable oils, tall oil and any mixture thereof and any derivative thereof.

The fatty acid chain component may be in either the 1-position or the 2-position of the glycerol.

Non edible vegetable oils are preferably selected from the fruit and seeds of Jatropha curcas, Calophyllum inophyllum, Sterculia feotida, Madhuca indica (mahua), Pongamia glabra (koroch seed), Linseed, Pongamia pinnata (karanja), Hevea brasiliensis (Rubber seed), Azadirachta indica (neem), Camelina sativa, Lesquerella fendleri, Nicotiana tabacum (tobacco), Deccan hemp, Ricinus communis L. (castor), Simmondsia chinensis (Jojoba), Eruca sativa. L., Cerbera odollam (Sea mango), Coriander (Coriandrum sativum L.), Croton megalocarpus, Pilu, Crambe, syringa, Scheleichera triguga (kusum), Stillingia, Shorea robusta (sal), Terminalia belerica roxb, Cuphea, Camellia, Champaca, Simarouba glauca, Garcinia indica, Rice bran, Hingan (balanites), Desert date, Cardoon, Asclepias syriaca (Milkweed), Guizotia abyssinica, Radish Ethiopian mustard, Syagrus, Tung, Idesia polycarpa var. vestita, Alagae, Argemone mexicana L. (Mexican prickly poppy, Putranjiva roxburghii (Lucky bean tree), Sapindus mukorossi (Soapnut), M. azedarach (syringe), Thevettia peruviana (yellow oleander), Copaiba, Milk bush, Laurel, Cumaru, Andiroba, Piqui, B. napus, Zanthoxylum bungeanum.

Preferably the triglyceride is hydrogenated to removed polyunsaturated alkyl chains such as linoleic and linoleneic acid. Preferred plant sources of oils are palm, rapeseed, sunflower, maze, soy, cottonseed, olive oil and trees, most preferably from rapeseed oil or a derivative thereof. The oil from trees is called tall oil.

Citric acid may be obtained from the fruit of citrus plants, preferably lemons and limes, or by fermentation using Aspergillus niger or Candida sp. from different sources of carbohydrates, such as molasses and starch-based media.

Hydrogenation of oils is described in: A Practical Guide to Vegetable Oil Processing (Gupta M. K. Academic Press 2017).

The citric acid may be in the 1-position, the 2-position or the 3-position of the glycerol. The ester bond may be formed with any of the COOH groups of the citric acid for example:

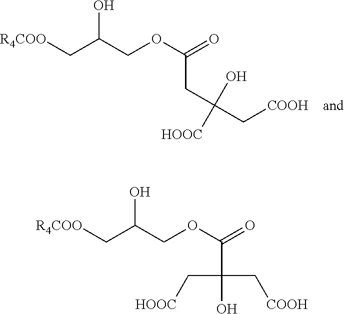

Preferred structures follow:

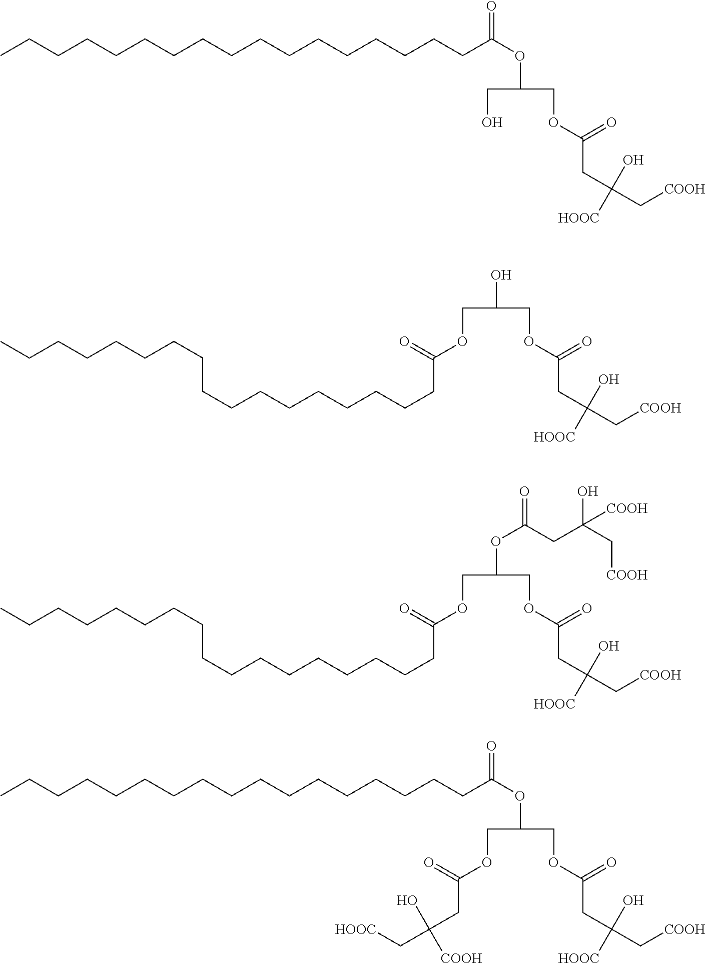 [SMILES: CCCCCCCCCCCCCCCCCC(=O)OC(CO)COC(=O)CC(O)(CC(=O)O)C(=O)O ; CCCCCCCCCCCCCCCCCC(=O)OCC(O)COC(=O)CC(O)(CC(=O)O)C(=O)O ; CCCCCCCCCCCCCCCCCC(=O)OCC(COC(=O)CC(O)(CC(=O)O)C(=O)O)OC(=O)CC(O)(CC(=O)O)C(=O)O ; CCCCCCCCCCCCCCCCCC(=O)OC(COC(=O)CC(O)(CC(=O)O)C(=O)O)COC(=O)CC(O)(CC(=O)O)C(=O)O]

And the palmitic, oleic, elaidic, cis and trans palmitoleic analogues thereof, for example:

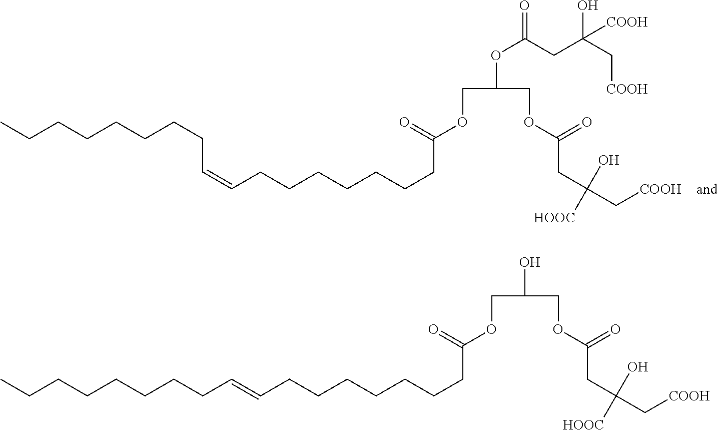 [SMILES: CCCCCCCC/C=C\CCCCCCCC(=O)OCC(COC(=O)CC(O)(CC(=O)O)C(=O)O)OC(=O)CC(O)(CC(=O)O)C(=O)O ; "and" ; CCCCCCCC/C=C/CCCCCCCC(=O)OCC(O)COC(=O)CC(O)(CC(=O)O)C(=O)O]

Preferably the citric acid ester of a monoglyceride is provided by a citrem preparation and the citrem preparation added to the laundry formulation. Citrem is also known as E472c Citric acid esters of mono- and diglycerides (citrem). Where is the E number is the codes for substances that are permitted to be used as food additives for use within the European Union.

The citrem preparation may be obtained by an esterification reaction between the citric acid and glycerides selected from mono-, di-glyceride and triglycerides, preferably mono-glycerides. The ratio between the reactants, the reaction temperature and the reaction time determines the degree of trans-esterification. Mono- and di-glyceride may be prepared by trans-esterification of tri-glycerides with glycerol, but other processes may be applied.

The citrem preparation preferably contains at least 40% (wt/wt) of a citric acid ester of a mono-glycerides, preferably at least 70% (wt/wt), more preferably at least 85% (wt/wt), even more preferably at least 90% (wt/wt), and most preferably at least 95% (wt/wt).

Preferably the ratio of (wt. % of citric acid ester of monoglyceride)/(wt. % of citric acid ester of diglyceride) is greater than 1, more preferably greater than 2, most preferably greater than 4.

Depending on the process for producing the dispersing agent it may not be possible to obtain a citrem preparation consisting entirely of citric acid esters of mono-glycerides. Therefore, the citrem preparation comprising carboxylic acid esters of mono- and diglycerides may furthermore comprise impurities such as triglycerides, diglycerides, monoglycerides and citric acid, citric acid esterified to glycerol, glycerol and free fatty acids. Preferably the level of these impurities is less than 50 wt. % of the citrem preparation. Preferably the sum of the level of triglyceride, diglyceride and monoglycerides is less than 20 wt. %, more preferably less than 5 wt. %, most preferably less than 1 wt. % of the citrem preparation.

The citrem preparation may contain polyglycerol esters, where the polyglycerol moiety is predominantly di-, tri- and tetraglycerol and contains not more than 10% of polyglycerols equal to or higher than heptaglycerol.

An example method of preparing the citric acid ester of monoglyceride involves heating a mixture of the prepared mono-glyceride and citric acid performs the esterification to give the citric acid ester of mono-glyceride. Mono-glyceride may be preheated before the addition of citric acid, and then the heating preferably is continued until reaction temperature is obtained. The temperature of the preheated mono-glyceride may generally be 80° C. to 120° C., preferably 90° C. to 110° C. and more preferably 100° C. The reaction temperature may generally be 100° C. to 160° C., preferably 120° C. to 150° C. and more preferably about 140° C. The reaction mixture is typically maintained at a pressure of 10 to about 760 mmHg, more preferably maintained at a pressure from about 20 to 200 mmHg and most preferably about 50 mmHg.

Generally, the esterification reaction may be performed for about 1-20 hours, preferably 5-10 hours and more preferably 8-10 hours.

Prior to and/or during the reaction, the reaction mixture may advantageously be covered with an inert gas such as nitrogen or place under a vacuum. The water being released during the reaction may continuously be removed from the reaction mixture by evaporating and condensing the water vapour or by placing under a vacuum.

Further Laundry Ingredients

Perfumes

The composition preferably comprises a perfume, preferably at a level of 0.05 to 2 wt. %. Many suitable examples of perfumes are provided in the CTFA (Cosmetic, Toiletry and Fragrance Association) 1992 International Buyers Guide, published by CFTA Publications and OPD 1993 Chemicals Buyers Directory 80th Annual Edition, published by Schnell Publishing Co.

Preferably the perfume comprises at least one note (compound) from: alpha-isomethyl ionone, benzyl salicylate; citronellol; coumarin; hexyl cinnamal; linalool; pentanoic acid, 2-methyl-, ethyl ester; octanal; benzyl acetate; 1,6-octadien-3-ol, 3,7-dimethyl-, 3-acetate; cyclohexanol, 2-(1,1-dimethylethyl)-, 1-acetate; delta-damascone; beta-ionone; verdyl acetate; dodecanal; hexyl cinnamic aldehyde; cyclopentadecanolide; benzeneacetic acid, 2-phenylethyl ester; amyl salicylate; beta-caryophyllene; ethyl undecylenate; geranyl anthranilate; alpha-irone; beta-phenyl ethyl benzoate; alpa-santalol; cedrol; cedryl acetate; cedry formate; cyclohexyl salicyate; gamma-dodecalactone; and, beta phenylethyl phenyl acetate.

Useful components of the perfume include materials of both natural and synthetic origin. They include single compounds and mixtures. Specific examples of such components may be found in the current literature, e.g., in Fenaroli's Handbook of Flavour Ingredients, 1975, CRC Press; Synthetic Food Adjuncts, 1947 by M. B. Jacobs, edited by Van Nostrand; or Perfume and Flavour Chemicals by S. Arctander 1969, Montclair, N.J. (USA).

It is commonplace for a plurality of perfume components to be present in a formulation. In the compositions of the present invention it is envisaged that there will be four or more, preferably five or more, more preferably six or more or even seven or more different perfume components.

In perfume mixtures preferably 15 to 25 wt. % are top notes. Top notes are defined by Poucher (Journal of the Society of Cosmetic Chemists 6(2):80 [1955]). Preferred top-notes are selected from citrus oils, linalool, linalyl acetate, lavender, dihydromyrcenol, rose oxide and cis-3-hexanol.

The International Fragrance Association has published a list of fragrance ingredients (perfumes) in 2011. (http://www.ifraorg.org/en-us/ingredients#.U7Z4hPldWzk) The Research Institute for Fragrance Materials provides a database of perfumes (fragrances) with safety information.

Perfume top note may be used to cue the whiteness and brightness benefit of the invention. Some or all of the perfume may be encapsulated, typical perfume components which it is advantageous to encapsulate, include those with a relatively low boiling point, preferably those with a boiling point of less than 300, preferably 100-250 Celsius. It is also advantageous to encapsulate perfume components which have a low C Log P (ie. those which will have a greater tendency to be partitioned into water), preferably with a C Log P of less than 3.0. These materials, of relatively low boiling point and relatively low C Log P have been called the “delayed blooming” perfume ingredients and include one or more of the following materials: allyl caproate, amyl acetate, amyl propionate, anisic aldehyde, anisole, benzaldehyde, benzyl acetate, benzyl acetone, benzyl alcohol, benzyl formate, benzyl iso valerate, benzyl propionate, beta gamma hexenol, camphor gum, laevo-carvone, d-carvone, cinnamic alcohol, cinamyl formate, cis-jasmone, cis-3-hexenyl acetate, cuminic alcohol, cyclal c, dimethyl benzyl carbinol, dimethyl benzyl carbinol acetate, ethyl acetate, ethyl aceto acetate, ethyl amyl ketone, ethyl benzoate, ethyl butyrate, ethyl hexyl ketone, ethyl phenyl acetate, eucalyptol, eugenol, fenchyl acetate, flor acetate (tricyclo decenyl acetate), frutene (tricyclco decenyl propionate), geraniol, hexenol, hexenyl acetate, hexyl acetate, hexyl formate, hydratropic alcohol, hydroxycitronellal, indone, isoamyl alcohol, iso menthone, isopulegyl acetate, isoquinolone, ligustral, linalool, linalool oxide, linalyl formate, menthone, menthyl acetphenone, methyl amyl ketone, methyl anthranilate, methyl benzoate, methyl benyl acetate, methyl eugenol, methyl heptenone, methyl heptine carbonate, methyl heptyl ketone, methyl hexyl ketone, methyl phenyl carbinyl acetate, methyl salicylate, methyl-n-methyl anthranilate, nerol, octalactone, octyl alcohol, p-cresol, p-cresol methyl ether, p-methoxy acetophenone, p-methyl acetophenone, phenoxy ethanol, phenyl acetaldehyde, phenyl ethyl acetate, phenyl ethyl alcohol, phenyl ethyl dimethyl carbinol, prenyl acetate, propyl bornate, pulegone, rose oxide, safrole, 4-terpinenol, alpha-terpinenol, and/or viridine. It is commonplace for a plurality of perfume components to be present in a formulation. In the compositions of the present invention it is envisaged that there will be four or more, preferably five or more, more preferably six or more or even seven or more different perfume components from the list given of delayed blooming perfumes given above present in the perfume.

Another group of perfumes with which the present invention can be applied are the so-called ‘aromatherapy’ materials. These include many components also used in perfumery, including components of essential oils such as Clary Sage, Eucalyptus, Geranium, Lavender, Mace Extract, Neroli, Nutmeg, Spearmint, Sweet Violet Leaf and Valerian.

Protease Enzymes

A protease enzyme is preferably present at a level of 0.0001 to 0.01 wt. %.

Protease enzymes hydrolyse bonds within peptides and proteins, in the laundry context this leads to enhanced removal of protein or peptide containing stains. Examples of suitable proteases families include aspartic proteases; cysteine proteases; glutamic proteases; aspargine peptide lyase; serine proteases and threonine proteases. Such protease families are described in the MEROPS peptidase database (http://merops.sanger.ac.uk/). Serine proteases are preferred. Subtilase type serine proteases are more preferred. The term “subtilases” refers to a sub-group of serine protease according to Siezen et al., Protein Engng. 4 (1991) 719-737 and Siezen et al. Protein Science 6 (1997) 501-523. Serine proteases are a subgroup of proteases characterized by having a serine in the active site, which forms a covalent adduct with the substrate. The subtilases may be divided into 6 sub-divisions, i.e. the Subtilisin family, the Thermitase family, the Proteinase K family, the Lantibiotic peptidase family, the Kexin family and the Pyrolysin family.

Examples of subtilases are those derived from Bacillus such as Bacillus lentus, B. alkalophilus, B. subtilis, B. amyloliquefaciens, Bacillus pumilus and Bacillus gibsonii described in; U.S. Pat. No. 7,262,042 and WO09/021867, and subtilisin lentus, subtilisin Novo, subtilisin Carlsberg, Bacillus licheniformis, subtilisin BPN′, subtilisin 309, subtilisin 147 and subtilisin 168 described in WO 89/06279 and protease PD138 described in (WO 93/18140). Other useful proteases may be those described in WO 92/175177, WO 01/016285, WO 02/026024 and WO 02/016547. Examples of trypsin-like proteases are trypsin (e.g. of porcine or bovine origin) and the Fusarium protease described in WO 89/06270, WO 94/25583 and WO 05/040372, and the chymotrypsin proteases derived from Cellumonas described in WO 05/052161 and WO 05/052146.

Most preferably the protease is a subtilase (EC 3.4.21.62).

Examples of subtilases are those derived from Bacillus such as Bacillus lentus, B. alkalophilus, B. subtilis, B. amyloliquefaciens, Bacillus pumilus and Bacillus gibsonii described in; U.S. Pat. No. 7,262,042 and WO09/021867, and subtilisin lentus, subtilisin Novo, subtilisin Carlsberg, Bacillus licheniformis, subtilisin BPN′, subtilisin 309, subtilisin 147 and subtilisin 168 described in WO89/06279 and protease PD138 described in (WO93/18140). Preferably the subsilisin is derived from Bacillus, preferably Bacillus lentus, B. alkalophilus, B. subtilis, B. amyloliquefaciens, Bacillus pumilus and Bacillus gibsonii as described in U.S. Pat. No. 6,312,936 BI, U.S. Pat. Nos. 5,679,630, 4,760,025, 7,262,042 and WO 09/021867. Most preferably the subtilisin is derived from Bacillus gibsonii or Bacillus Lentus.

Suitable commercially available protease enzymes include those sold under the trade names names Alcalase®, Blaze®; Duralase™, Durazym™, Relase®, Relase® Ultra, Savinase®, Savinase® Ultra, Primase®, Polarzyme®, Kannase®, Liquanase®, Liquanase® Ultra, Ovozyme®, Coronase®, Coronase® Ultra, Neutrase®, Everlase® and Esperase® all could be sold as Ultra® or Evity® (Novozymes A/S).

Amylase Enzymes

An amylase enzyme is preferably present at a level of 0.0001 to 0.01 wt. %.

Suitable amylases (alpha and/or beta) include those of bacterial or fungal origin. Chemically modified or protein engineered mutants are included. Amylases include, for example, alpha-amylases obtained from Bacillus, e.g. a special strain of B. licheniformis, described in more detail in GB 1,296,839, or the Bacillus sp. strains disclosed in WO 95/026397 or WO 00/060060. Commercially available amylases are Duramyl™, Termamyl™, Termamyl Ultra™, Natalase™, Stainzyme™, Fungamyl™ and BAN™ (Novozymes A/S), Rapidase™ and Purastar™ (from Genencor International Inc.).

Cellulase Enzymes

A cellulase enzyme is preferably present at a level of 0.0001 to 0.01 wt. %.

Suitable cellulases include those of bacterial or fungal origin. Chemically modified or protein engineered mutants are included. Suitable cellulases include cellulases from the genera Bacillus, Pseudomonas, Humicola, Fusarium, Thielavia, Acremonium, e.g. the fungal cellulases produced from Humicola insolens, Thielavia terrestris, Myceliophthora thermophila, and Fusarium oxysporum disclosed in U.S. Pat. Nos. 4,435,307, 5,648,263, 5,691,178, 5,776,757, WO 89/09259, WO 96/029397, and WO 98/012307. Commercially available cellulases include Celluzyme™, Carezyme™, Celluclean™, Endolase™ Renozyme™ (Novozymes A/S), Clazinase™ and Puradax HA™ (Genencor International Inc.), and KAC-500(B)™ (Kao Corporation). Celluclean™ is preferred.

Any enzyme present in the composition may be stabilized using conventional stabilizing agents, e.g., a polyol such as propylene glycol or glycerol, a sugar or sugar alcohol, lactic acid, boric acid, or a boric acid derivative, e.g., an aromatic borate ester, or a phenyl boronic acid derivative such as 4-formylphenyl boronic acid, and the composition may be formulated as described in e.g. WO 92/19709 and WO 92/19708

Preservatives

A preservative is preferably present in the formulation to prevent bacterial, mold or fungal growth.

Preferably the composition comprises from 0.0001 to 1 wt. %, preferably from 0.001 to 0.5 wt. %, more preferably from 0.001 to 0.25 wt. % of a preservative.

Many preservatives are described in Handbook of Preservatives (M. Ash Synapse Info Resources 2004).

Examples of suitable preservatives are isothiazolinone preservatives. The preferred isothiazolinone preservatives are benzisothiazolinone and/or methylisothiazolinone.

Further Ingredients

The formulation may contain further ingredients.

Further Surfactant

Surfactants are discussed in the Surfactant Science Series published by CRC press, series editor: Arthur T. Hubbard.

Further surfactant may be present at a preferable level of from 0.5 to 40 wt. %, more preferably from 1 to 30 wt. %.

The surfactants are preferably readily biodegradable, according to OECD301.

The composition may preferably comprise nonionic surfactant. Preferably the non-ionic surfactant is selected from saturated and mono-unsaturated aliphatic alcohol ethoxylates and saturated and mono-unsaturated fatty acid sugar esters. More preferably the non-ionic surfactant is saturated and mono-unsaturated aliphatic alcohol ethoxylates, preferably selected from C₁₂ to C₂₀ primary linear alcohol ethoxylates with an average of from 5 to 30 ethoxylates, more preferably C₁₆ to C₁₈ with an average of from 7 to 20 ethoxylates.

The formulation may comprise anionic detergent compounds which preferably are: rhamnolipids, tartartic acid esters and diacetyltartaric acid esters of a C₁₆ to C₁₈ monoglyceride (tatem and datem); C₁₂ to C₁₈ alkyl ether carboxylate and water-soluble alkali metal salts of organic sulphates, ether sulphates and sulphonates having alkyl radicals containing from about 8 to about 22 carbon atoms, the term alkyl being used to include the alkyl portion of higher alkyl radicals.

Examples of further suitable anionic detergent compounds are: sodium and potassium alkyl C₉ to C₂₀ benzene sulphonates, particularly sodium linear secondary alkyl Cao to C₁₅ benzene sulphonates and alkyl (preferably methyl) ester sulphonates, and mixtures thereof.

Preferably these are present at lower levels than the citric acid ester of monoglyceride, preferably the weight fraction of further anionic surfactant/glyceride carboxylate is from 0 to 0.4, preferably 0 to 0.1.

Preferably the surfactants used are saturated or mono-unsaturated.

To prevent oxidation of the formulation an anti-oxidant may be present in the formulation.

Soil Release Polymer

It is preferred that a soil release polymer is included.

The laundry detergent composition preferably comprises from 0.1 to 8 wt. % of a soil release polymer.

Preferred levels of soil release polymer range from 0.2 to 6 wt. %, more preferably from 0.5 to 5 wt. %, most preferably from 1 to 5 wt. %.

Preferably the soil release polymer is a polyester soil release polymer.

More preferably the polyester soil release polymer is a polyethylene and/or polypropylene terephthalate based soil release polymer, most preferably a polypropylene terephthalate based soil release polymer.

Suitable polyester based soil release polymers are described in WO 2014/029479 and WO 2016/005338.

Preferably the polyester based soil release polymer is a polyester according to the following formula (1)

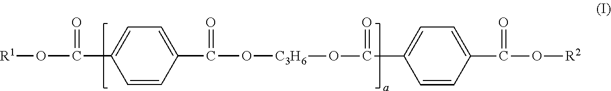

wherein
R¹ and R² independently of one another are X—(OC₂H₄)ₙ—(OC₃H₆)ₘ wherein X is C₁₋₄ alkyl and preferably methyl, the —(OC₂H₄) groups and the —(OC₃H₆) groups are arranged blockwise and the block consisting of the —(OC₃H₆) groups is bound to a COO group or are HO—(C₃H₆), and preferably are independently of one another X—(OC₂H₄)ₙ—(OC₃H₆)ₘ,
n is based on a molar average number of from 12 to 120 and preferably of from 40 to 50,
m is based on a molar average number of from 1 to 10 and preferably of from 1 to 7, and
a is based on a molar average number of from 4 to 9.

Preferably the polyester provided as an active blend comprising:

A) from 45 to 55% by weight of the active blend of one or more polyesters according to the following formula (1)

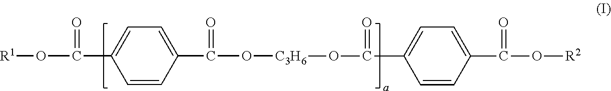

wherein
R¹ and R² independently of one another are X—(OC₂H₄)ₙ—(OC₃H₆)ₘ wherein X is C₁₋₄ alkyl and preferably methyl, the —(OC₂H₄) groups and the —(OC₃H₆) groups are arranged blockwise and the block consisting of the —(OC₃H₆) groups is bound to a COO group or are HO—(C₃H₆), and preferably are independently of one another X—(OC₂H₄)ₙ—(OC₃H₆)ₘ,
n is based on a molar average number of from 12 to 120 and preferably of from 40 to 50,
m is based on a molar average number of from 1 to 10 and preferably of from 1 to 7, and
a is based on a molar average number of from 4 to 9 and
B) from 10 to 30% by weight of the active blend of one or more alcohols selected from the group consisting of ethylene glycol, 1,2-propylene glycol, 1,3-propylene glycol, 1,2-butylene glycol, 1,3-butylene glycol, 1,4-butylene glycol and butyl glycol and
C) from 24 to 42% by weight of the active blend of water.

Alkoxylated Polyamine

When the detergent composition is in the form of a laundry composition, it is preferred that an alkoxylated polyamine is included.

The laundry detergent preferably comprises from 0.1 to 8 wt. % of an alkoxylated polyamine.

Preferred levels of alkoxylated polyamine range from 0.2 to 6 wt. %, more preferably from 0.5 to 5 wt. %. Another preferred level is from 1 to 4 wt. %.

The alkoxylated polyamine may be linear or branched. It may be branched to the extent that it is a dendrimer. The alkoxylation may typically be ethoxylation or propoxylation, or a mixture of both. Preferably the alkoxylated polyamine comprises an alkoxylated polyethylenimine, and/or alkoxylated polypropylenimine, more preferably the alkoxylation is ethoxylation or propoxylation or a mixture of both. Where a nitrogen atom is alkoxylated, a preferred average degree of alkoxylation is from 10 to 30, preferably from 15 to 25.

A preferred material is alkoxylated polyethylenimine, most preferably ethoxylated polyethyleneimine, with an average degree of ethoxylation being from 10 to 30 preferably from 15 to 25, where a nitrogen atom is ethoxylated.

Additional Enzymes

Additional enzymes, other than the specified protease, amylase or cellulase may be present in the detergent composition. It is preferred that additional enzymes are present in the preferred laundry detergent composition.

If present, then the level of each enzyme in the laundry composition of the invention is from 0.0001 wt. % to 0.1 wt. %.

Levels of enzyme present in the composition preferably relate to the level of enzyme as pure protein.

Preferred further enzymes include those in the group consisting of: lipases, peroxidases/oxidases, pectate lyases, and/or mannanases. Said preferred additional enzymes include a mixture of two or more of these enzymes.

Preferably the further enzyme is a lipase.

Suitable lipases include those of bacterial or fungal origin. Chemically modified or protein engineered mutants are included. Examples of useful lipases include lipases from Humicola (synonym Thermomyces), e.g. from H. lanuginosa (T. lanuginosus) as described in EP 258 068 and EP 305 216 or from H. insolens as described in WO 96/13580, a Pseudomonas lipase, e.g. from P. alcaligenes or P. pseudoalcaligenes (EP 218 272), P. cepacia (EP 331 376), P. stutzeri (GB 1,372,034), P. fluorescens, Pseudomonas sp. strain SD 705 (WO 95/06720 and WO 96/27002), P. wisconsinensis (WO 96/12012), a Bacillus lipase, e.g. from B. subtilis (Dartois et al. (1993), Biochemica et Biophysica Acta, 1131, 253-360), B. stearothermophilus (JP 64/744992) or B. pumilus (WO 91/16422). Other examples are lipase variants such as those described in WO 92/05249, WO 94/01541, EP 407 225, EP 260 105, WO 95/35381, WO 96/00292, WO 95/30744, WO 94/25578, WO 95/14783, WO 95/22615, WO 97/04079 and WO 97/07202, WO 00/60063.

Preferred commercially available lipase enzymes include Lipolase™ and Lipolase Ultra™, Lipex™ and Lipoclean™ (Novozymes A/S).

The method of the invention may be carried out in the presence of phospholipase classified as EC 3.1.1.4 and/or EC 3.1.1.32. As used herein, the term phospholipase is an enzyme which has activity towards phospholipids.

Phospholipids, such as lecithin or phosphatidylcholine, consist of glycerol esterified with two fatty acids in an outer (sn-1) and the middle (sn-2) positions and esterified with phosphoric acid in the third position; the phosphoric acid, in turn, may be esterified to an amino-alcohol. Phospholipases are enzymes which participate in the hydrolysis of phospholipids. Several types of phospholipase activity can be distinguished, including phospholipases A₁ and A₂ which hydrolyze one fatty acyl group (in the sn-1 and sn-2 position, respectively) to form lysophospholipid; and lysophospholipase (or phospholipase B) which can hydrolyze the remaining fatty acyl group in lysophospholipid. Phospholipase C and phospholipase D (phosphodiesterases) release diacyl glycerol or phosphatidic acid respectively.

The composition may use cutinase, classified in EC 3.1.1.74. The cutinase used according to the invention may be of any origin. Preferably cutinases are of microbial origin, in particular of bacterial, of fungal or of yeast origin.

Suitable peroxidases/oxidases include those of plant, bacterial or fungal origin. Chemically modified or protein engineered mutants are included. Examples of useful peroxidases include peroxidases from Coprinus, e.g. from C. cinereus, and variants thereof as those described in WO 93/24618, WO 95/10602, and WO 98/15257. Commercially available peroxidases include Guardzyme™ and Novozym™ 51004 (Novozymes A/S).

Further enzymes suitable for use are discussed in WO 2009/087524, WO 2009/090576, WO 2009/107091, WO 2009/111258 and WO 2009/148983.

The aqueous solution used in the method preferably has an enzyme present. The enzyme is preferably present in the aqueous solution used in the method at a concentration in the range from 0.01 to 10 ppm, preferably 0.05 to 1 ppm.

Enzyme Stabilizers

Any enzyme present in the composition may be stabilized using conventional stabilizing agents, e.g., a polyol such as propylene glycol or glycerol, a sugar or sugar alcohol, lactic acid, boric acid, or a boric acid derivative, e.g., an aromatic borate ester, or a phenyl boronic acid derivative such as 4-formylphenyl boronic acid, and the composition may be formulated as described in e.g. WO 92/19709 and WO 92/19708.

Chelating Agent

Chelating agents may be present or absent from the detergent compositions.

The detergent compositions described herein may also contain one or more metal ion chelating agents beyond the citric acid compounds concomitant with the citric acid ester of the monoglyceride.

Suitable molecules include copper, iron and/or manganese chelating agents and mixtures thereof. Such chelating agents can be selected from the group consisting of phosphonates, amino carboxylates, amino phosphonates, succinates, polyfunctionally-substituted aromatic chelating agents, 2-pyridinol-N-oxide compounds, hydroxamic acids, and mixtures thereof.

Chelating agents can be present in the acid or salt form including alkali metal, ammonium, and substituted ammonium salts thereof, and mixtures thereof.

Aminocarboxylates useful as chelating agents include, but are not limited to ethylenediaminetetracetates (EDTA); N-(hydroxyethyl)ethylenediaminetriacetates (HEDTA); nitrilotriacetates (NTA); ethylenediamine tetraproprionates; triethylenetetraaminehexacetates, diethylenetriamine-pentaacetates (DTPA); methylglycinediacetic acid (MGDA); Glutamic acid diacetic acid (GLDA); ethanoldiglycines; triethylenetetraaminehexaacetic acid (TTHA); N-hydroxyethyliminodiacetic acid (HEIDA); dihydroxyethylglycine (DHEG); ethylenediaminetetrapropionic acid (EDTP) and derivatives thereof.

Phosphorus containing chelants include, but are not limited to diethylene triamine penta (methylene phosphonic acid) (DTPMP CAS 15827-60-8); ethylene diamine tetra(methylene phosphonic acid) (EDTMP CAS 1429-50-1); 2-Phosphonobutane 1,2,4-tricarboxylic acid (Bayhibit® AM); hexamethylene diamine tetra(methylene phosphonic acid) (CAS 56744-47-9); hydroxy-ethane diphosphonic acid (HEDP CAS 2809-21-4); hydroxyethane dimethylene phosphonic acid; 2-phosphono-1,2,4-Butanetricarboxylic acid (CAS 37971-36-1); 2-hydroxy-2-phosphono-Acetic acid (CAS 23783-26-8); Aminotri(methylenephosphonic acid) (ATMP CAS 6419-19-8); P,P′-(1,2-ethanediyl)bis-Phosphonic acid (CAS 6145-31-9); P,P′-methylenebis-Phosphonic acid (CAS 1984-15-2); Triethylenediaminetetra(methylene phosphonic acid) (CAS 28444-52-2); P-(1-hydroxy-1-methylethyl)-Phosphonic acid (CAS 4167-10-6); bis(hexamethylene triamine penta(methylenephosphonic acid)) (CAS 34690-00-1); N2,N2,N6,N6-tetrakis(phosphonomethyl)-Lysine (CAS 194933-56-7, CAS 172780-03-9), salts thereof, and mixtures thereof. Preferably, these aminophosphonates do not contain alkyl or alkenyl groups with more than about 6 carbon atoms.

A biodegradable chelator that may also be used herein is ethylenediamine disuccinate (“EDDS”). The trisodium salt of EDDA may be used, though other forms, such as magnesium salts, may also be useful. Polymeric chelants such as Trilon P® from BASF may also be useful.

Polyfunctionally-substituted aromatic chelating agents may also be used in the cleaning compositions. Compounds of this type in acid form are dihydroxydisulfobenzenes, such as 1,2-dihydroxy-3,5-disulfobenzene, also known as Tiron. Other sulphonated catechols may also be used. In addition to the disulfonic acid, the term “tiron” may also include mono- or di-sulfonate salts of the acid, such as, for example, the disodium sulfonate salt, which shares the same core molecular structure with the disulfonic acid.

Other suitable chelating agents for use herein are the commercial DEQUEST series, and chelants from Monsanto, Akzo-Nobel, DuPont, Dow, the Trilon® series from BASF and Nalco.

The chelant may be present in the detergent compositions disclosed herein at from about 0.005% to about 15% by weight, about 0.01% to about 5% by weight, about 0.1% to about 3.0% by weight, or from about 0.2% to about 0.7% by weight, or from about 0.3% to about 0.6% by weight of the detergent compositions disclosed herein. Preferably if present, then the chelating agent is present at a level of from 0.01 to 5 wt. %.

The composition preferably contains less than 1 wt. % of phosphorous containing materials.

The composition may contain alkoxylated polycarboxylic acid esters as described in WO/2019/008036 and WO/2019/007636.

Builders or Complexing Agents

The composition may comprise a builder.

Builder materials may be selected from 1) calcium sequestrant materials, 2) precipitating materials, 3) calcium ion-exchange materials and 4) mixtures thereof.

Examples of calcium sequestrant builder materials include alkali metal polyphosphates, such as sodium tripolyphosphate and organic sequestrants, such as ethylene diamine tetra-acetic acid.

Examples of precipitating builder materials include sodium orthophosphate and sodium carbonate.

Examples of calcium ion-exchange builder materials include the various types of water-insoluble crystalline or amorphous aluminosilicates, of which zeolites are well known representatives thereof, e.g. zeolite A, zeolite B (also known as zeolite P), zeolite C, zeolite X, zeolite Y and also the zeolite P-type as described in EP-A-0,384,070.

The composition may also contain 0-65 wt. % of a builder or complexing agent such as ethylenediaminetetraacetic acid, diethylenetriamine-pentaacetic acid, alkyl- or alkenylsuccinic acid, nitrilotriacetic acid or the other builders mentioned below. Many builders are also bleach-stabilising agents by virtue of their ability to complex metal ions.

Zeolite and carbonate (carbonate (including bicarbonate and sesquicarbonate) are preferred builders, with carbonates being particularly preferred.

The composition may contain as builder a crystalline aluminosilicate, preferably an alkali metal aluminosilicate, more preferably a sodium aluminosilicate. This is typically present at a level of less than 15 wt. %.

Aluminosilicates are materials having the general formula:

0.8-1.5 M₂O. Al₂O₃. 0.8-6 SiO₂,

where M is a monovalent cation, preferably sodium.

These materials contain some bound water and are required to have a calcium ion exchange capacity of at least 50 mg CaO/g. The preferred sodium aluminosilicates contain 1.5-3.5 SiO₂ units in the formula above. They can be prepared readily by reaction between sodium silicate and sodium aluminate, as amply described in the literature. The ratio of surfactants to alumuminosilicate (where present) is preferably greater than 5:2, more preferably greater than 3:1.

Alternatively, or additionally to the aluminosilicate builders, phosphate builders may be used. In this art the term ‘phosphate’ embraces diphosphate, triphosphate, and phosphonate species. Other forms of builder include silicates, such as soluble silicates, metasilicates, layered silicates (e.g. SKS-6 from Hoechst).

More preferably the laundry detergent formulation is a non-phosphate built laundry detergent formulation, i.e., contains less than 1 wt. % of phosphate. Most preferably the laundry detergent formulation is not built i.e. contain less than 1 wt. % of builder.

If the detergent composition is an aqueous liquid laundry detergent it is preferred that mono propylene glycol is present at a level from 1 to 30 wt. %, most preferably 2 to 18 wt. %, to provide the formulation with appropriate, pourable viscosity.

Fluorescent Agent

The composition preferably comprises a fluorescent agent (optical brightener).

Fluorescent agents are well known and many such fluorescent agents are available commercially. Usually, these fluorescent agents are supplied and used in the form of their alkali metal salts, for example, the sodium salts.

The total amount of the fluorescent agent or agents used in the composition is generally from 0.0001 to 0.5 wt. %, preferably 0.005 to 2 wt. %, more preferably 0.01 to 0.1 wt. %. Preferred classes of fluorescer are: Di-styryl biphenyl compounds, e.g. Tinopal (Trade Mark) CBS-X, Di-amine stilbene di-sulphonic acid compounds, e.g. Tinopal DMS pure Xtra and Blankophor (Trade Mark) HRH, and Pyrazoline compounds, e.g. Blankophor SN. Preferred fluorescers are fluorescers with CAS-No 3426-43-5; CAS-No 35632-99-6; CAS-No 24565-13-7; CAS-No 12224-16-7; CAS-No 13863-31-5; CAS-No 4193-55-9; CAS-No 16090-02-1; CAS-No 133-66-4; CAS-No 68444-86-0; CAS-No 27344-41-8.

Most preferred fluorescers are: sodium 2 (4-styryl-3-sulfophenyl)-2H-napthol[1,2-d]triazole, disodium 4,4′-bis{[(4-anilino-6-(N methyl-N-2 hydroxyethyl) amino 1,3,5-triazin-2-yl)]amino}stilbene-2-2′ disulphonate, disodium 4,4′-bis{[(4-anilino-6-morpholino-1,3,5-triazin-2-yl)]amino} stilbene-2-2′ disulphonate, and disodium 4,4′-bis(2-sulphostyryl)biphenyl.

Shading Dye

It is advantageous to have shading dye present in the formulation.

Dyes are described in Color Chemistry Synthesis, Properties and Applications of Organic Dyes and Pigments, (H Zollinger, Wiley VCH, Zurich, 2003) and, Industrial Dyes Chemistry, Properties Applications. (K Hunger (ed), Wiley-VCH Weinheim 2003).

Dyes for use in laundry detergents preferably have an extinction coefficient at the maximum absorption in the visible range (400 to 700 nm) of greater than 5000 L mol⁻¹ cm⁻¹, preferably greater than 10000 L mol⁻¹ cm⁻¹.

Preferred dye chromophores are azo, azine, anthraquinone, phthalocyanine and triphenylmethane. Azo, anthraquinone, phthalocyanine and triphenylmethane dyes preferably carry a net anionic charged or are uncharged. Azine dyes preferably carry a net anionic or cationic charge.

Blue or violet Shading dyes are most preferred. Shading dyes deposit to fabric during the wash or rinse step of the washing process providing a visible hue to the fabric. In this regard the dye gives a blue or violet colour to a white cloth with a hue angle of 240 to 345, more preferably 260 to 320, most preferably 270 to 300. The white cloth used in this test is bleached non-mercerised woven cotton sheeting.

Shading dyes are discussed in WO2005/003274, WO2006/032327 (Unilever), WO2006/032397 (Unilever), WO2006/045275 (Unilever), WO 2006/027086 (Unilever), WO2008/017570 (Unilever), WO 2008/141880 (Unilever), WO2009/132870 (Unilever), WO 2009/141173 (Unilever), WO 2010/099997 (Unilever), WO 2010/102861 (Unilever), WO 2010/148624 (Unilever), WO2008/087497 (P&G), WO2011/011799 (P&G), WO2012/054820 (P&G), WO2013/142495 (P&G), WO2013/151970 (P&G), WO2018/085211 (P&G), and WO2019/075149 (P&G).

A mixture of shading dyes may be used.

The shading dye chromophore is most preferably selected from mono-azo, bis-azo and azine.

Mono-azo dyes preferably contain a heterocyclic ring and are most preferably thiophene dyes. The mono-azo dyes are preferably alkoxylated and are preferably uncharged or anionically charged at pH=7. Alkoxylated thiophene dyes are discussed in WO2013/142495 and WO2008/087497. A preferred example of a thiophene dye is shown below:

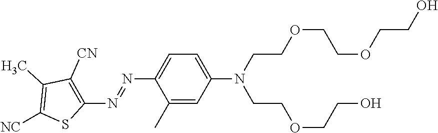 [SMILES: Cc1cc(N(CCOCCO)CCOCCOCCO)ccc1/N=N/c1sc(C#N)c(C)c1C#N]

Bis-azo dyes are preferably sulphonated bis-azo dyes. Preferred examples of sulphonated bis-azo compounds are direct violet 7, direct violet 9, direct violet 11, direct violet 26, direct violet 31, direct violet 35, direct violet 40, direct violet 41, direct violet 51, direct violet 66, direct violet 99 and alkoxylated versions thereof.

Alkoxylated bis-azo dyes are discussed in WO2012/054058 and WO/2010/151906. An example of an alkoxylated bis-azo dye is:

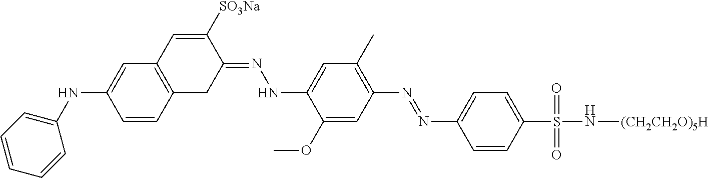

Azine dyes are preferably selected from sulphonated phenazine dyes and cationic phenazine dyes. Preferred examples are acid blue 98, acid violet 50, dye with CAS-No 72749-80-5, acid blue 59, and the phenazine dye selected from:

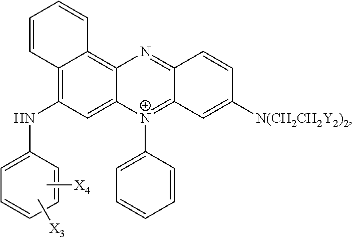

wherein:

X₃ is selected from: —H; —F; —CH₃; —C₂H₅; —OCH₃; and, —OC₂H₅;

X₄ is selected from: —H; —CH₃; —C₂H₅; —OCH₃; and, —OC₂H₅;

Y₂ is selected from: —OH; —OCH₂CH₂OH; —CH(OH)CH₂OH; —OC(O)CH₃; and, C(O)OCH₃.

Anthraquinone dyes covalently bound to ethoxylate or propoxylated polyethylene imine may be used as described in WO2011/047987 and WO 2012/119859.

The shading dye is preferably present is present in the composition in range from 0.0001 to 0.1 wt %. Depending upon the nature of the shading dye there are preferred ranges depending upon the efficacy of the shading dye which is dependent on class and particular efficacy within any particular class. As stated above the shading dye is preferably a blue or violet shading dye.

Polymers

The composition may comprise one or more further polymers. Examples are carboxymethylcellulose, poly (ethylene glycol), poly(vinyl alcohol), polycarboxylates such as polyacrylates, maleic/acrylic acid copolymers and lauryl methacrylate/acrylic acid copolymers.

Where alkyl groups are sufficiently long to form branched or cyclic chains, the alkyl groups encompass branched, cyclic and linear alkyl chains. The alkyl groups are preferably linear or branched, most preferably linear.

The detergent compositions optionally include one or more laundry adjunct ingredients.

The term “adjunct ingredient” includes: perfumes, dispersing agents, stabilizers, pH control agents, metal ion control agents, colorants, brighteners, dyes, odour control agent, pro-perfumes, cyclodextrin, perfume, solvents, soil release polymers, preservatives, antimicrobial agents, chlorine scavengers, anti-shrinkage agents, fabric crisping agents, spotting agents, anti-oxidants, anti-corrosion agents, bodying agents, drape and form control agents, smoothness agents, static control agents, wrinkle control agents, sanitization agents, disinfecting agents, germ control agents, mould control agents, mildew control agents, antiviral agents, antimicrobials, drying agents, stain resistance agents, soil release agents, malodour control agents, fabric refreshing agents, chlorine bleach odour control agents, dye fixatives, dye transfer inhibitors, shading dyes, colour maintenance agents, colour restoration, rejuvenation agents, anti-fading agents, whiteness enhancers, anti-abrasion agents, wear resistance agents, fabric integrity agents, anti-wear agents, and rinse aids, UV protection agents, sun fade inhibitors, insect repellents, anti-allergenic agents, enzymes, flame retardants, water proofing agents, fabric comfort agents, water conditioning agents, shrinkage resistance agents, stretch resistance agents, and combinations thereof. If present, such adjuncts can be used at a level of from 0.1% to 5% by weight of the composition

The indefinite article “a” or “an” and its corresponding definite article “the” as used herein means at least one, or one or more, unless specified otherwise.

The invention will be further described with the following non-limiting examples.

### EXAMPLES

### Experimental

Citric acid ester of monoglyceride were dissolved in 24 degree French hard water to give a 0.3 g/L solution. The citric acid esters were provided by a commercial citrem based on C18 vegetable oils (Grindsted citrem SP70 MB ex DuPont). 800 ml of the solution was used to wash four 5×5 cm EMPA 117 stain monitor (blood/milk/ink stain on polycotton) in a tergotometer set at 200 rpm.

The wash is equivalent to dosing 6 g/L of a laundry treatment composition containing 10 wt. % of surfactant and 0.001 wt. % preservative. The wash took 60 minutes at a temperature of 30° C. The wash was repeated using water alone.

Once the wash had been completed the monitors were rinsed once in 400 ml clean water, removed dried and the colour measured on a reflectometer and expressed as the CIE L*a*b* values.

Stain removal was calculated as the ΔL* value:

ΔL*=L*(after wash)−L*(before wash)

Higher ΔL* value equate to better cleaning.

The results alongside the 95% confidence limits are given in the following table.

| | ΔL* | 95% |
|---|---|---|
| Citric acid ester of monoglyceride | 16.3 | 0.4 |
| Water (control) | 9.1 | 0.4 |

The citric acid ester of monoglyceride provides good cleaning of the stain in hard water conditions.

1. An aqueous laundry detergent composition, comprising:
a) from 2 to 95 wt. %, preferably from 2.5 to 50 wt. %, more preferably from 5 to 50 wt. % of a citric acid ester derivative of a monoglyceride of the form:— 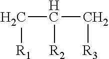
wherein one of R₁, R₂, and R₃ is selected from a C₁₆ to C₁₈ fatty acid chain; and one or two of R₁, R₂, and R₃ is selected from citric acid, the remainder, if any being OH; and,
b) from 0.0001 to 5 wt. %, of further laundry ingredients selected from: protease enzymes, amylase enzymes, and cellulase enzymes.

2. (canceled)

3. A laundry detergent composition according to claim 1, wherein the fatty acid chain component of the citric acid ester of a monoglyceride is a linear or branched, preferably linear, saturated or monounsaturated chain.

4. A laundry detergent composition according to claim 1, wherein the fatty acid chain component is preferably selected from palmitic, cis and trans palmitoleic, stearic, oleic and elaidic, most preferably palmitic and stearic.

5. A laundry detergent composition according to claim 1 wherein only one of R₁, R₂, and R₃ is selected from citric acid.

6. A laundry detergent composition according to claim 1, comprising an nonionic surfactant selected from saturated and mono-unsaturated aliphatic alcohol ethoxylates and saturated and mono-unsaturated fatty acid sugar esters; preferably the non-ionic surfactant is saturated and mono-unsaturated aliphatic alcohol ethoxylates, preferably selected from C₁₂ to C₂₀ primary linear alcohol ethoxylates with an average of from 5 to 30 ethoxylates, more preferably C₁₆ to C₁₈ with an average of from 7 to ethoxylates.

7. A laundry detergent composition according to claim 1, comprising an anionic surfactant selected from: rhamnolipids, tartartic acid esters and diacetyltartaric acid esters of a C16 to C18 monoglyceride (tatem and datem), C₁₂ to C₁₈ alkyl ether carboxylate and water-soluble alkali metal salts of organic sulphates, ether sulphates and sulphonates having alkyl radicals containing from about 8 to about 22 carbon atoms.

8. A laundry detergent composition according to claim 1, wherein the laundry detergent composition comprises an alkoxylated polyamine, preferably at a level of from 0.1 to 8 wt. %, more preferably from 0.2 to 6 wt. %, most preferably from 0.5 to 5 wt. %, preferably the alkoxylated polyamine is an alkoxylated polyethylenimine, and/or alkoxylated polypropylenimine, more preferably the alkoxylation is ethoxylation or propoxylation or a mixture of both.

9. A laundry detergent composition according to claim 1, wherein the laundry detergent composition comprises a soil release polymer, preferably at a level of from 0.1 to 8 wt. %, more preferably from 0.2 to 6 wt. %, most preferably from 0.5 to 5 wt. %, preferably the soil release polymer is a polyester soil release polymer.

10. A laundry detergent composition according to claim 1, comprising one or more further enzymes selected from the group consisting of: lipases, peroxidases/oxidases, pectate lyases, and/or mannanases.

11. A laundry detergent composition according to claim 1, wherein when a liquid detergent, said detergent has a viscosity greater than or equal to 1 cP (centipoise), preferably from 1 to 6000 cP, more preferably from 200 to 1000 cP, said viscosity measured at a shear rate of 21 s−1 and at a temperature of 25° C. on any commercial stress rheometer, available for example from Anton Paar or Malvern.

12. A laundry detergent composition according to claim 1, wherein the pH of the formulation when dissolved at 2 g/L in demineralised water at 20° C. is from pH 3 to 10, preferably from 4 to 8, more preferably 6.5 to 7.5.

13. (canceled)

14. A domestic method of treating a textile, comprising the steps of:—
a) treating a textile with an aqueous solution of 0.15 to 20 g/L, more preferably 1 to 10 g/L of the detergent composition according to claim 1;
b) optionally rinsing and drying the textile.

15. A laundry detergent composition according to claim 1, further comprising a perfume and/or preservative.
